(19) United States
(12) Patent Application Publication
(10) Pub. No.: US 2023/0377429 A1
(43) Pub. Date: Nov. 23, 2023

(54) ROOT CANAL ACTIVATOR AND THE METHOD OF ACTIVATION

(71) Applicant: CHANGSHA EASYINSMILE INTELLIGENCE TECHNOLOGY CO,LTD, CHANGSHA (CN)

(72) Inventors: TIRAN ZHANG, CHANGSHA (CN); DAN GUO, CHANGSHA (CN)

(21) Appl. No.: 18/362,928

(22) Filed: Jul. 31, 2023

Related U.S. Application Data
(63) Continuation of application No. 17/070,892, filed on Oct. 14, 2020, now abandoned.

(30) Foreign Application Priority Data
Dec. 30, 2019 (CN) 201911392096.X
Mar. 16, 2020 (CN) 202010180491.8
Aug. 16, 2020 (CN) 202010822174.1

(51) Int. Cl. G08B 5/36; A61C 5/40; A61C 1/07; A61C 1/00

(52) U.S. Cl. CPC G08B 5/36; A61C 5/40; A61C 1/07; A61C 1/0015; A61C 2204/002

(57) ABSTRACT

This invention is about a root canal activator and the activation method. It belongs to technical field of root canal treatment equipment. The eccentric wheel is connected with a oscillatory needle, which is composed of a needle head, a spherical joint and a connecting rod. The connecting rod is connected through a spherical joint to the ball-shaped slot of the eccentric wheel and therefore, a spherical pair is formulated to allow for a degree of freedom. There is a head cover made of soft rubber mounted at the top end of the outer shell. The oscillatory needle is mounted inside the soft rubber cover through a cylindrical joint, which has formulated a cylindrical pair and allows for five degrees of freedom in total.

### CROSS-REFERENCE TO RELATED APPLICATIONS

This application is a continuation of utility application Ser. No. 17/070,892, filed Oct. 14^{th}, 2020, now pending, which claims priority to Chinese Patent Applications No. 202010180491.8 filed Mar. 16^{th} 2020, No. 201911392096.X, filed Dec. 30^{th} 2019, No. 202010822174.1 filed Aug. 16^{th}. 2020. The content of the aforementioned applications, including any intervening amendments thereto, are incorporated herein by reference.

### TECHNICAL FILED

This invention involves a root canal activator and the activation method. It belongs to technical field of root canal treatment equipment.

### BACKGROUND

Currently, activators used for root canal treatment on the market are ultrasonic activators, which has the following disadvantages:

Needles of ultrasonic activators are made of metal structures, which tend to stop working immediately after being blocked.

1. Needles of ultrasonic activators are connected by axes and bolts, which means more restraint and less freedom, especially no movement freedom on X and Y axes of the working plane. If being blocked by the inner wall of the root canal, the needle may be deadlocked and stop working.

2. Needles of ultrasonic activators are metallic, which can break easily on colliding with inner wall of the root canal. However skilled the doctor may be, the patient's head movement caused for example by coughing may bring about needle colliding and breaking. Moreover, a broken needle is very difficult to be taken out, which not only brings inconvenience to the patients and doctors, but also affects the treatment and result in physical and psychological injuries. It is very dangerous.

3. Ultrasonic activators have no medicine-spraying or applying function. If the doctors change needles or use other ways to apply medicine, the treatment will be prolonged and become more complicated.

4. A root canal activator mainly includes two components, the driving structure and the needle. By manually adjusting oscillation intensity, the doctor can thoroughly cleanse the root canal of infecting substances, remove residual bacteria and toxins and finally cure the root canal. However, hybrid control of the added sterilizing UVC lamp, 3-geared LED indicators and the motor may render the voltage volatile, therefore, a constant voltage technique is urgently needed to guarantee stable power supply.

### SUMMARY OF THE DISCLOSURE

The invention providing a root canal activator and its activation method will overcome shortcomings of the existing techniques.

The invention is realized by the following technical plan: the activator is composed of the oscillatory needle mounted on the top of the outer shell, the battery lid on the bottom of the outer shell and the battery compartment inside the outer shell, the battery lid is screwed on the bottom of the outer shell. Inside the shell, there are the PCB main control board, motor and keys. The motor is connected with the PCB main control board through key connectors. Positive and negative anodes of the PCB main control board, motor and keys are respectively connected with the positive and negative plates inside the battery compartment. The battery is installed inside the battery compartment.

The PCB main control board is fixed in the front of the outer shell, the keys are embedded into the outer shell, when being pressed, bottom of the keys will contact the electronic elements on the PCB main control board.

The motor is mounted on the front of the motor support. The motor is connected with the eccentric wheel by an input axis at the front end.

The eccentric wheel is connected with an oscillatory needle, which is composed of a needle, a spherical joint and a connecting rod. The connecting rod is connected through the spherical joint to the ball-shaped slot of the eccentric wheel and therefore, a spherical pair is formulated to allow for some degree of freedom.

There is a head cover made of soft rubber mounted at the end of the outer shell. The oscillatory needle is mounted inside the soft rubber cover through a cylindrical joint, which has formulated a cylindrical pair and allows for four degrees of freedom. Therefore, there are five degrees of freedom in total. The oscillatory needle is mounted on the ring slot inside the soft rubber head cover through the cylindrical joint, while a seal is installed between the cylindrical joint and the ring slot.

The above mentioned needle has a threaded texture.

There is a driver board connected with the PCB main control board. The driver board is wired with the UVC Lamps and the three-geared LED string lights. The PCB main control board uses keys to operate the driver board and motor.

The PCB main control board is mainly composed of a motor driver module, voltage-boosting and voltage-stabilizing modules, MCU controller and indicator controller. The voltage-boosting and voltage-stabilizing modules will provide constant voltage to the motor driver module, MCU controller and indicator controller during their hybrid operation.

The voltage-boosting and voltage-stabilizing modules include a differential comparator and a preset reference voltage value, which use voltage feedback to modulate value of the output voltage.

The voltage-boosting and voltage-stabilizing modules collaborate to control the motor and the three-geared LED string lights display.

When the MCU controller and the motor driver module control the motor to work at gear 1, the Pt LED indicator will be lighted by the indicator controller, when the motor works at gear 2, the 1^{st} and 2^{nd} LED indicators will be lighted; when at gear 3, the 1^{st}, 2^{nd} and 3^{rd} LED indicators will be lighted.

The activating method of this invention include the following steps:

Step 1. Install the battery. Screw the battery lid clockwise; prepare the root canal, make a tapered opening which can host the needle; press down the power key for 3 seconds until it beeps to indicate being switched on.

Step 2. Prepare plans to inject irrigation solutions of NaOCL, EDTA, etc into root canals.

Step 3. Apply medicine by immersing threaded part of the needle into the medicine and insert the medicine-soaked needle into the root canal.

Step 4. Start treatment, press down the power key to start the activator, operate the needle to move on elliptical traces to apply medicine from threaded part of the needle evenly onto the root canal wall for disinfecting effects; in the course of treatment, gears can be changed from gear 1 to gear 3 by pressing key to adjust intensity of activation. The treatment can also be suspended or resumed by pressing keys.

Step 5. Self-adapt. When the oscillatory needle feels the frictional drag inside the root canal, the soft rubber head cover will deform at the ring slot susceptible to force from the needle to realize self-adaptation and avoid deadlock.

Step 6. Finish treatment. Press keys to adjust vibration on account of sensitivity of the patient. Finish treatment when expected efficacy is achieved. Then, turn off the activator by pressing the power key for 3 seconds.

During the above step 4, if the LED lights corresponding to the 3 gears take a constant white light, it means the system has full power. If the LED lights take a constant reddish white color, it means the system has half power. If the LED lights take a constant red color, it means the system is short in power. If the power indicator takes a flickering red color, it means the system is close to power outage.

During the above step 5, when put into high gear, the top, middle and bottom indicators will be lighted; when put into middle gear, the top and middle indicators will be lighted; when put into low gear, the top indicator will be lighted.

When the oscillatory needle keeps working for 8 minutes without operation, or the needle stops working without operation, the activator will switch off automatically. You must follow the above step 4 to restart the activator.

The constant voltage control of this invention include the following steps:

Step 1. Using keys on the PCB main control board to change gears.

Step 2. When first connected to power, the voltage-boosting and voltage-stabilizing modules will compare the input voltage with the reference voltage. If the input voltage is higher than the reference voltage, the logical circuit on the PCB main control board will control the battery to supply power to the driver board and motor.

Step 3. When the logical circuit on the PCB main control detects the input voltage is lower than the reference voltage, PFM will control the logic circuit to start driver and boost voltage in line with the voltage demand of different gears and provide power to the motor.

Step 4. After the triode circuit in the voltage-boosting and voltage-stabilizing modules and the logic circuit on the PCB main control board has modulated voltage for a while, the battery voltage will go below the critical value. Then, the logic gate of constant voltage circuit will run voltage comparison and confirm to turn off power supply. At this time, voltage in the circuit is zero. When enabling CE is high, the voltage-boosting and voltage-stabilizing modules will receive voltage feedback to modulate output voltage,

Uout=(R1+R2)*R1/Uref

During the above step 2, when there is an input voltage, the voltage-boosting and voltage-stabilizing modules will generate a reference voltage, which will act on the positive pole of the differential comparator. When the output voltage is higher than the set value, voltage feedback from the output end to the negative pole of differential comparator will be increased correspondingly. At this time, voltage value on the differential comparator's negative pole is higher than at the positive pole, therefore, the differential comparator will lower its output voltage. Therefore, output duty ratio of the logical circuit will be reduced by the PWM, the output voltage will be decreased until it is approximately equal to the reference voltage. Vice versa, when the output voltage is lower than the reference voltage, voltage on the positive pole of the differential comparator will be higher than on the negative pole, under the PWM control, output duty ratio of the logical circuit will increase and the output voltage will be boosted until a stable state is reached.

At voltage above 1.3V, the indicator will turn white, which means full power. At voltage of 1.2-1.3V, the indicator will turn white and red, which means half power. At voltage of 0.95-1.2V, the indicator will turn red, which means low power. At voltage of 0.9-0.95V, the indicator will flicker red, which means extremely low power.

Advantages of this invention include: 1. Movement self-adaptation. When the needle is blocked, it can automatically change its movement by self-adapting to the situation and avoid the activator being stopped. 2. the movement freedom of spherical and cylindrical joints can guarantee safety and security of the needle. The oscillatory needle and the spherical and cylindrical joints forming a highly free connection structure at the soft rubber head cover has five degrees of freedom. 3. the small-torqued motor will not cause deadlock on the part of the needle. 4. the needle will not snap, therefore it is safer. 5. the needle's threaded texture is convenient to spraying or applying medicine. 6. during hybrid operation of sterilizing UVC lamp, 3-geared LED indicators and the motor, power supply of constant voltage to various electronic elements can guarantee stable voltage and service life of the activator.

### BRIEF DESCRIPTION OF THE DRAWINGS

FIG. 1 is a schematic diagram of the root canal activator according to one embodiment of the present invention.

FIG. 2 is a sectional view of the root activator according to one embodiment of the present invention.

FIG. 3 is a schematic diagram of the oscillatory needle according to one embodiment of the present invention.

FIG. 4 is a simplified schematic diagram of the connection between the oscillatory needle and the eccentric wheel according to one embodiment of the present invention.

FIG. 5 is a schematic diagram of the root activator according to alternative embodiment of the present invention.

FIG. 6 is a sectional view of the root activator according to alternative embodiment of the present invention.

FIG. 7 is a schematic diagram of the oscillatory needle according to alternative embodiment of the present invention.

FIG. 8 shows the movement trace of the oscillatory needle according to embodiments of the present invention.

FIG. 9 is a simplified schematic diagram of the PCB main control board.

FIG. 10 shows a circuit diagram of the main board.

FIG. 11 shows voltage curves under different loads.

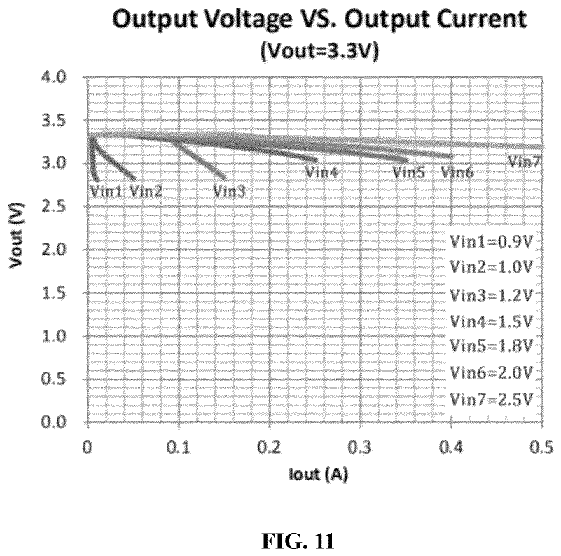

FIG. 12 shows a circuit diagram of the UVC.

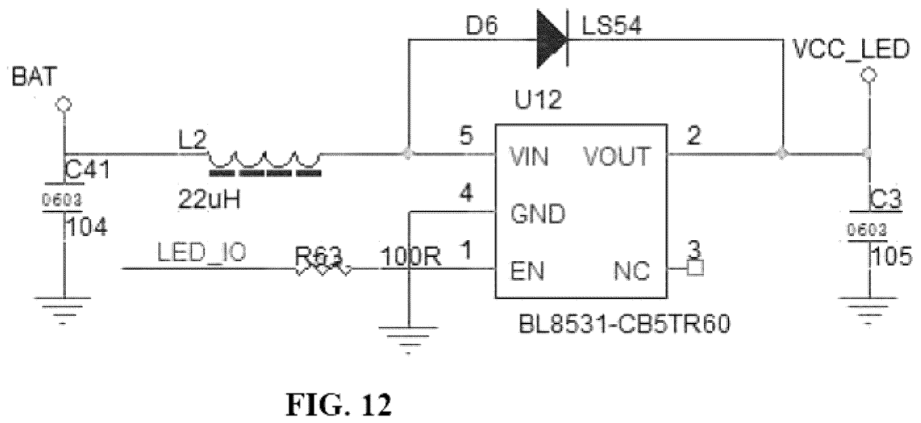

FIG. 13 shows a circuit diagram of the motor driver board.

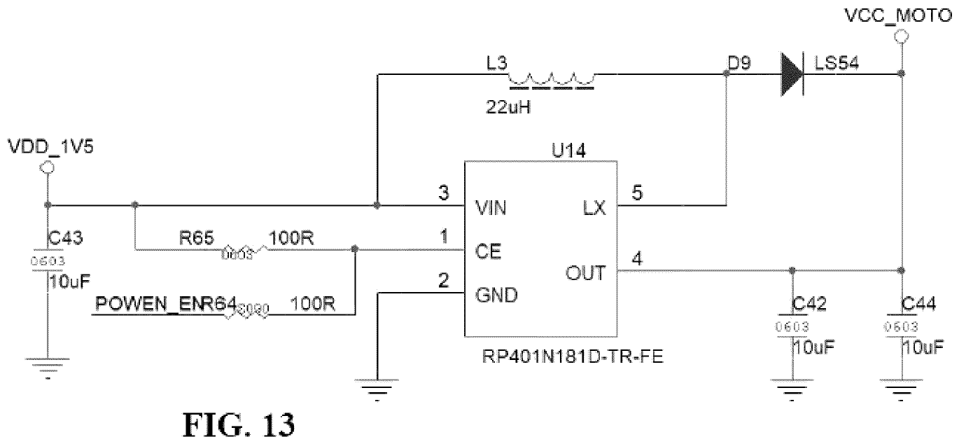

FIG. 14 shows a circuit diagram of the LED.

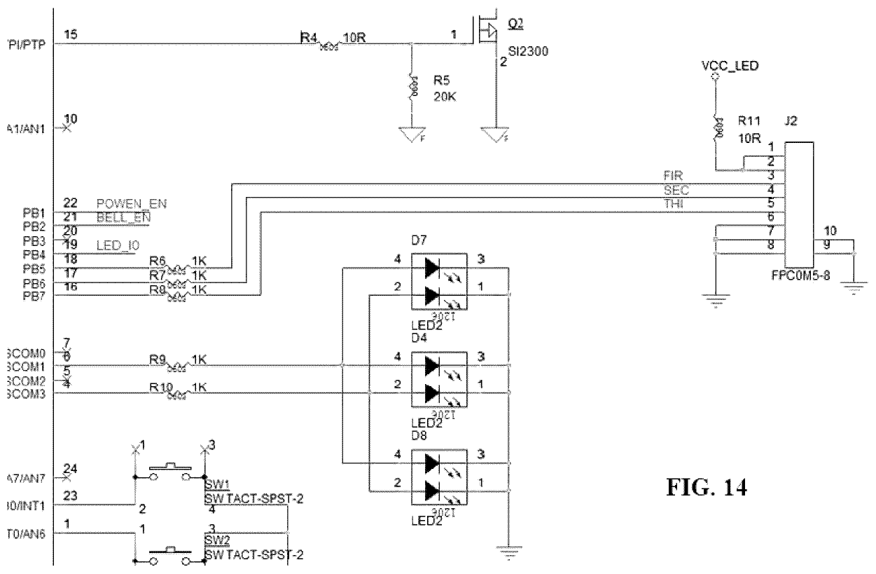

### DETAILED DESCRIPTION OF THE DISCLOSURE

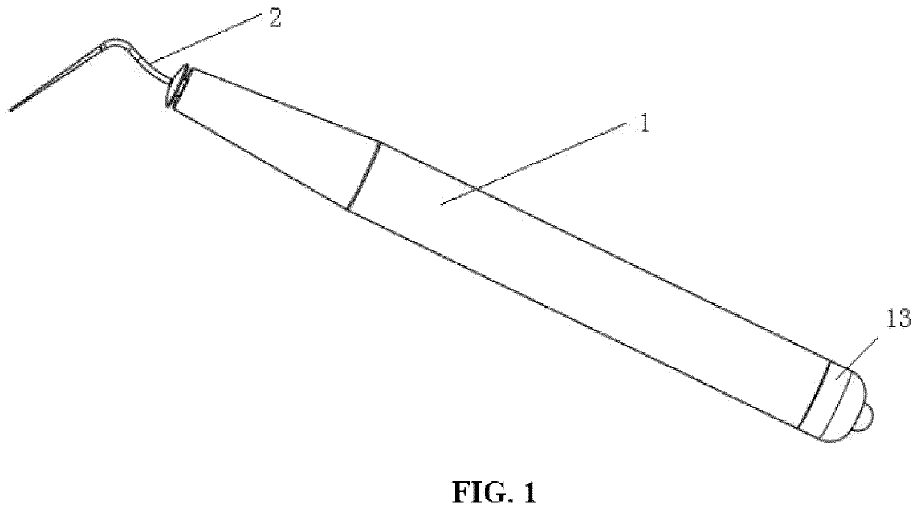

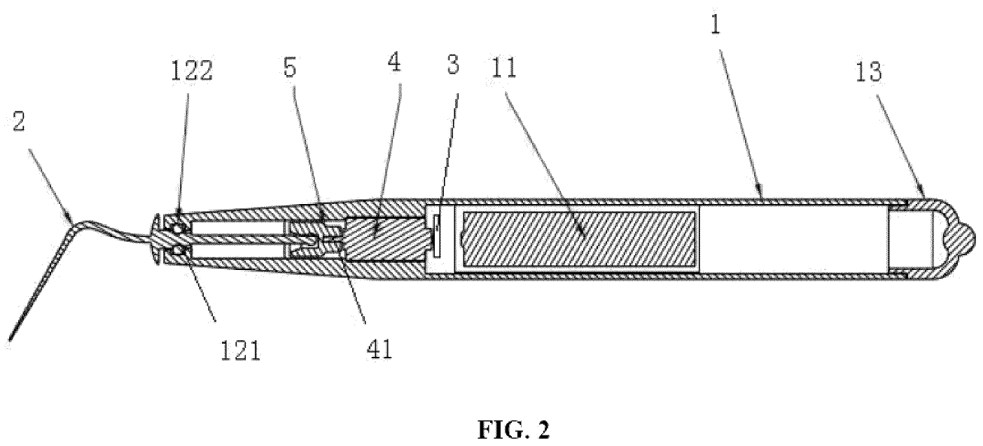

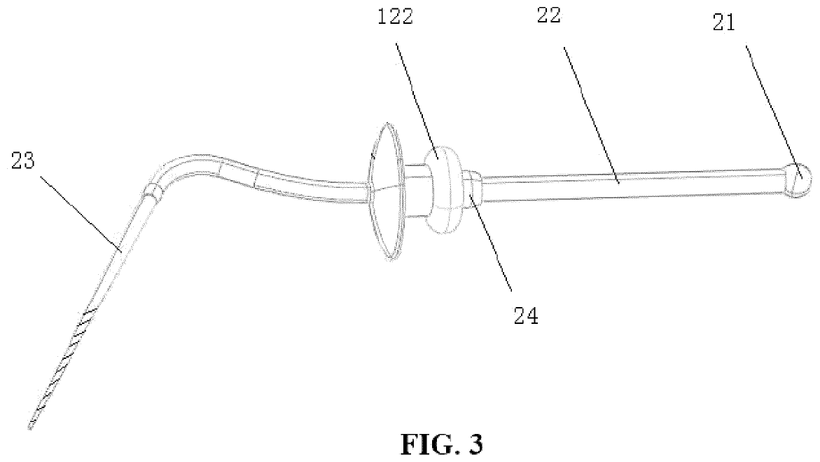

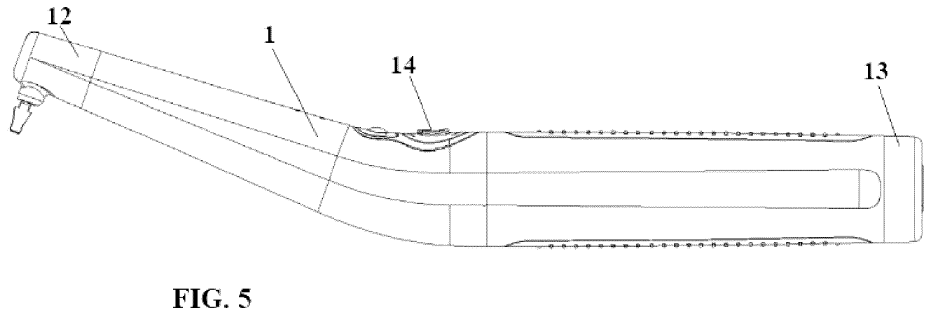

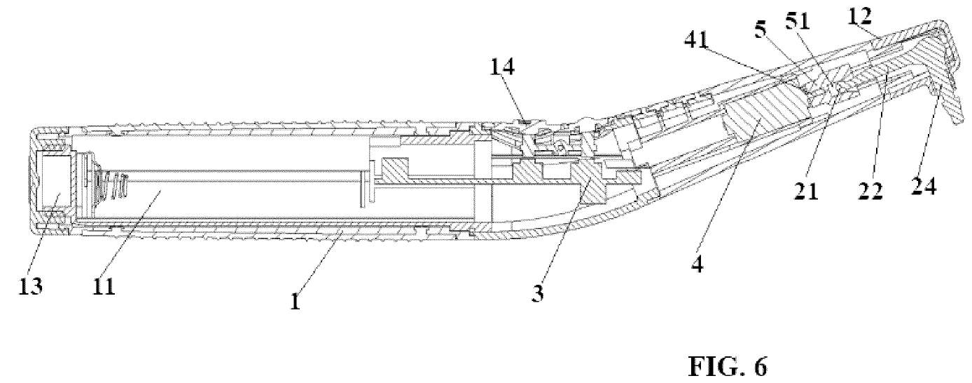

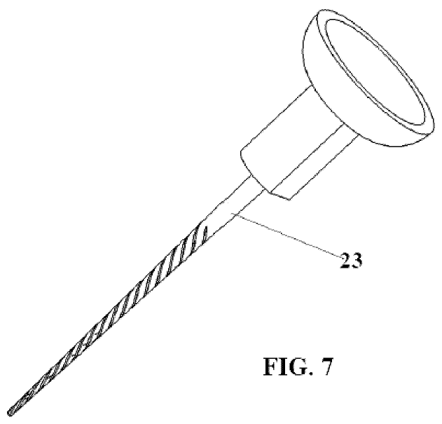

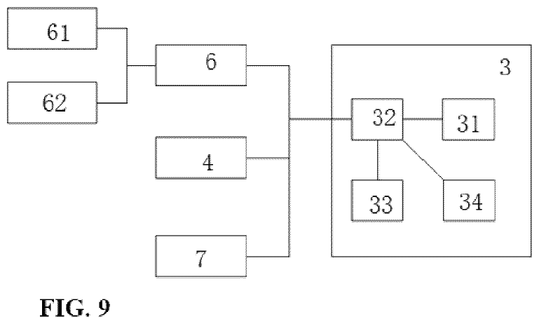

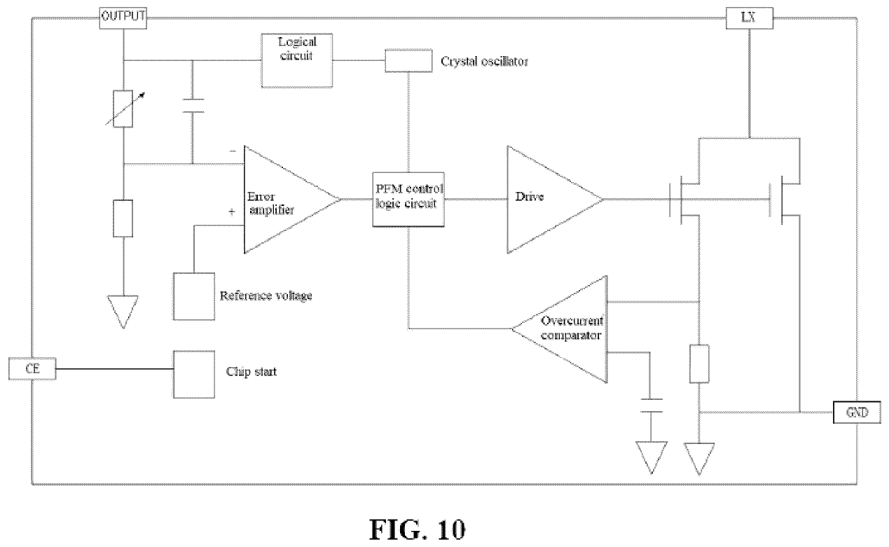

Next, we will use FIGS. 1-10 appended herein to explain the exemplary case of this invention, which includes the oscillatory needle (2) mounted on the top of the outer shell (1), the battery lid (13) on the bottom, and the battery compartment (11) inside the outer shell (1). The battery lid (13) is screwed onto the bottom of the outer shell (1). Inside the outer shell (1), there are PCB main control board (3), motor (4), and the key (14). The motor (4) is connected with the PCB main control board (3) through key connectors. Positive and negative anodes of the PCB main control board (3), motor (4), and the key (14) are respectively connected with the positive and negative plates inside the battery compartment. The battery (7) is installed inside the battery compartment (11). The PCB main control board (3) is fixed inside the front end of the outer shell (1). The key (14) is embedded into the outer shell (1). When being pressed, bottom of the key (14) will touch the electronic elements on the PCB main control board (3).

The motor (4) is mounted on the front of the motor support (41). The motor (4) is connected with the eccentric wheel (5) by an input axis at the front end.

The eccentric wheel (5) is connected with an oscillatory needle (2), which is composed of the needle head (23), a spherical joint (21) and a connecting rod (22). The connecting rod (22) is connected through a spherical joint (21) to the ball-shaped slot (51) of the eccentric wheel (5) and therefore, a spherical pair is formulated to allow for some degree of freedom.

There is a head cover (12) made of soft rubber mounted at the end of the outer shell (1). The oscillatory needle (2) is mounted inside the soft rubber cover (12) through a cylindrical joint (24), which has formulated a cylindrical pair and allows for four degrees of freedom. Therefore, there are five degrees of freedom in total. The oscillatory needle (2) is mounted on the ring slot (121) inside the soft rubber head cover (12) through the cylindrical joint (24), while a seal (122) is installed between the cylindrical joint (24) and the ring slot (121).

The above mentioned needle head (23) has a threaded texture.

To be more specific, freedom of motion of the needle head (23) of the oscillatory needle (2) along the X, Y axis is restrained. The flexible connection inside the soft rubber head cover (12) allows for the other 4 degrees of freedom. Meanwhile, since there is rigid connection inside the flexible structure, lengthwise displacement is difficult to happen.

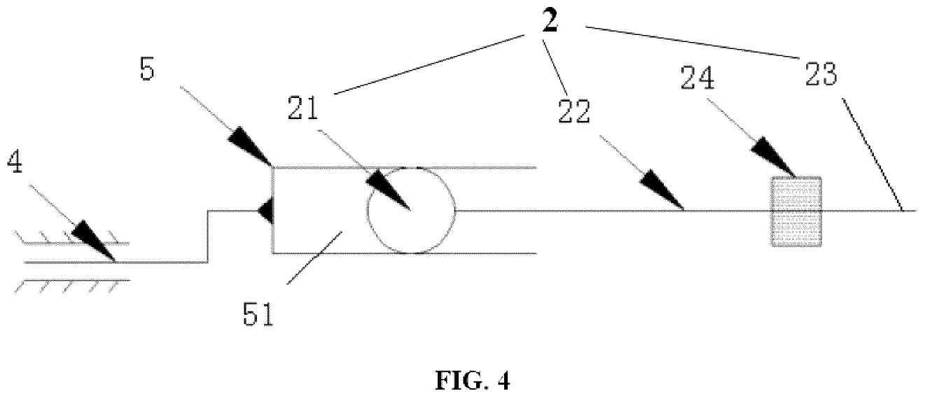

FIG. 4 shows how it works: Input axis (41) of the motor is connected with the eccentric wheel (5). The connecting rod (22) is connected with the eccentric wheel (5) by a spherical pair, which only restrains two degrees of freedom along the X and Y axis. The other end of the connecting rod (22) is linked with the ring seal (122) made of flexible materials with Shore Hardness of 30-60.

In this case, when the motor (4) stops working, the needle head (23) will settle on the flexible material with a force balance. Once the motor (4) restarts, through the eccentric wheel (5), it will drive the spherical pair of the connecting rod (22) to rotate.

Analyzing with mechanical theory, it is found if without the ring seal (122), the mechanical structure shall have the following degree of freedom:

F=6n−5p5−4p4−3p3−2p2−p1;

In the above equation, F means the structure's degree of freedom, n means the number of mobile parts, p5 means having one degree of freedom, p4 means having 2 degrees of freedom, p3 means having 3 degrees of freedom, p2 means having 4 degrees of freedom, and p1 means having 5 degrees of freedom.

As for this invention, F=6n−5p5−2p2=6x2−5x1−2x1=5.

In the above equation, F refers to the structure's degree of freedom, n refers to the number of mobile parts. n=2, which includes 1 spherical pair and 1 cylindrical pair. This invention only has p5 and p2, therefore, it has 5 restrained parts.

After calculation, it is found if the flexible material is not used to fasten the mechanical parts, the machine would have only 5 degrees of freedom, however, after the flexible materials is used, if we treat the ring seal (122) as a rigid part, the machine would be jammed dead, or even if the motor (4) could overcome the deformation of the connecting rod (22), there would still be no output of power. But if we use the ring seal (122) made of flexible material, the machine can easily overcome the flexible material and bring about plastic deformation. In this case, there is almost no friction between parts of the machine and no additional noise will come out.

As illustrated in FIG. 4, rigidity of the connecting rod (22) is larger than that of the flexible material of the ring seal (122). But, the motor (4) can produce flexible deformation irrespective of the rigid connecting rod (22). Therefore, when the connecting rod (22) is jammed dead at the working end, the motor (4) still can overcome deformation of the connecting rod (22) to continue working, instead of transmitting excessive working energy onto the needle, which ensures the needle will not be over-stressed, and keeps the motor safe and secure and extends lifespan of the machine.

From the above analysis, it is found no matter what extreme conditions happen at the load end, there is a dual safety design to ensure the needle will not break or become overloaded, which further guarantees safety of the whole machine.

There is also a driver board (6) connected with the PCB main control board (3). The driver board (6) is wired with the UVC Lamps (61) and the three-geared LED string lights (62). The PCB main control board (3) uses the key (14) to operate the driver board (6) and motor (4).

The PCB main control board (3) is mainly composed of a motor driver module (31), voltage-boosting and voltage-stabilizing modules (32), MCU controller (33) and indicator controller (34).

The voltage-boosting and voltage-stabilizing modules (32) will provide constant voltage to the motor driver module (31), MCU controller (33) and indicator controller (34) during their hybrid operation.

The voltage-boosting and voltage-stabilizing modules (32) include a differential comparator and a preset reference voltage value, which use voltage feedback to modulate value of the output voltage.

The voltage-boosting and voltage-stabilizing modules (32) collaborate to control the motor (4) and the three-geared LED string lights display (62).

When the MCU controller (33) and the motor driver module (31) control the motor (4) to work at gear 1, the Pt LED indicator will be lighted by the indicator controller (34), when the motor works at gear 2, the 1^{st} and 2^{nd} LED indicators will be lighted by the indicator controller (34); when at gear 3, the 1^{st}, 2^{nd} and 3^{rd} LED indicators will be lighted by the indicator controller (34).

The activation method of this invention include the following steps:

Step 1. Install the battery. Screw the battery lid (13) clockwise; prepare the root canal by making a tapered opening which can host the needle; press down the power key (14) for 3 seconds until it beeps to indicate being switched on.

Step 2. Prepare plans to inject irrigation solutions of NaOCL, EDTA, etc into root canals.

Step 3. Apply medicine by immersing threaded part of the needle head (23) into the medicine and insert the medicine-soaked needle head (23) into the root canal.

Step 4. Start treatment, press down the power key (14) to start the activator, operate the needle head (23) to move on elliptical tracks to apply medicine from threaded part of the needle head (23) evenly onto the root canal wall for disinfecting effects; in the course of treatment, gears can be changed from gear 1 to gear 3 by pressing key (14) to change gears for adjusting intensity of activation. The treatment can also be suspended or resumed by pressing key (14).

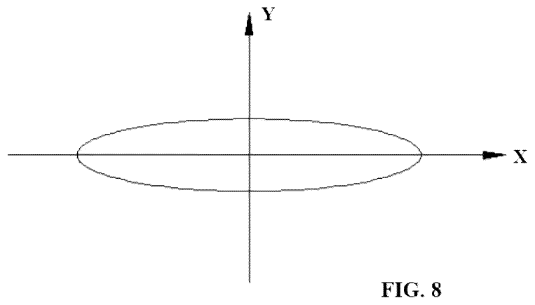

Step 5. Self-adapt. When the oscillatory needle (2) feels the frictional drag inside the root canal, the soft rubber head cover (12) will deform at the ring slot susceptible to force from the needle head (23) to realize self-adaptation and avoid deadlock. FIG. 8 shows movement tracks of the oscillatory needle (2) under no-friction conditions.

Step 6. Finish treatment. Press the key (14) to adjust vibration on account of sensitivity of the patient. Finish treatment when expected efficacy is achieved. Then, turn off the activator by pressing the power key (14) for 3 seconds.

During the above step 4, if the LED string lights (62) corresponding to the 3 gears take a constant white color, it means the system has full power. If the LED string lights (62) take a constant reddish white color, it means the system has half power. If the LED string lights (62) take a constant red color, it means the system is short in power. If the power indicator takes a flickering red color, it means the system is close to power outage.

During the above step 5, when put into high gear, the top, middle and bottom indicators will be lighted; when put into middle gear, the top and middle indicators will be lighted; when put into low gear, the top indicator will be lighted.

When the oscillatory needle (2) keeps working for 8 minutes without operation, or the needle (2) stops working without operation, the system will switch off automatically. You must follow the above step 4 to restart the activator.

The constant voltage control of this invention include the following steps:

Step 1. Using the key (14) on the PCB main control board (3) to change gears.

Step 2. When first connected to power, the voltage-boosting and voltage-stabilizing modules (32) will compare the input voltage with the reference voltage. If the input voltage is higher than the reference voltage, the logical circuit on the PCB main control board (3) will control the battery (7) to supply power to the driver board (6) and motor (4).

Step 3. When the logical circuit on the PCB main control board (3) detects the input voltage is lower than the reference voltage, PFM will control the logic circuit to start driver and boost voltage in line with the voltage demand of different gears and provide power to the motor (4).

Step 4. After the triode circuit in the voltage-boosting and voltage-stabilizing modules (32) and the logic circuit on the PCB main control board (3) has modulated voltage for a while, the battery voltage will go below the critical value. Then, the logic gate of constant voltage circuit will run voltage comparison and confirm to turn off power supply. At this time, voltage in the circuit is zero. When enabling CE is high, the voltage-boosting and voltage-stabilizing modules (32) will receive voltage feedback to modulate output voltage,

Uout=(R1+R2)*R1/Uref

Because the machine uses 1.5V dry battery or 5.0V lithium battery to supply power, when first connected to power, the stable voltage source circuit will compare the input voltage with the reference voltage. If the input voltage is higher than the reference voltage, the logical circuit will control the battery (7) to supply power directly to the circuit boards and relevant devices. After supplying power for some time, when the logical circuit detects the input voltage is lower than the reference voltage, PFM will control the logic circuit to start the driver and boost voltage. This time, according to different voltage demands, it will provide 2V and 6V power respectively to the motor and UVC lamp. After the triode circuit and the logic circuit in the constant voltage source have modulated voltage for a while, the battery voltage will go below the critical value, then, the logic gate of constant voltage circuit will run voltage comparison and confirm to turn off power supply. At this time, voltage in the circuit is zero.

BL08531-CBTR60 is a DCDC converter based on the CMOS PFM boost. The converter has a minimum supply voltage of 0.8V, a maximum output electric current of 300 mA and a switch-operating frequency of 450 khz. The BL08531 series has integrated the stable reference circuits and trimming techniques, which can withstand high precision, low temperature and shift factor.

By BL08531-CBTR60, power can be supplied to the UVC.

When the system has high IO: LED_IO, VCC-LED will output 6V voltage. In table 1 below are shown testing data of UVC with different voltages:

TABLE 1

| | Power Supply INPUT | | | | | | | | | | | |
|---|---|---|---|---|---|---|---|---|---|---|---|---|
| | 1.15 v | | 1.21 | | 1.31 | | 1.41 | | 1.51 | | 1.54 | |
| UVC Power | 5.9 | V | 5.9 | V | 5.9 | V | 5.9 | V | 5.9 | V | 5.9 | V |
| Supply | | | | | | | | | | | | |
| UVC Electric | 50 | MA | 50 | MA | 50 | MA | 50 | MA | 50 | MA | 50 | MA |
| Current | | | | | | | | | | | | |

During the above step 2, when there is an input voltage, the voltage-boosting and voltage-stabilizing modules (32) will generate a reference voltage, which will act on the positive pole of the differential comparator. When the output voltage is higher than the set value, voltage feedback from the output end to the negative pole of differential comparator will be increased correspondingly. At this time, voltage value on the differential comparator's negative pole is higher than at the positive pole, therefore, the differential comparator will lower its output voltage. Therefore, output duty ratio of the logical circuit will be reduced by the PWM, the output voltage will be decreased until it is approximately equal to the reference voltage. Vice versa, when the output voltage is lower than the reference voltage, voltage on the positive pole of the differential comparator will be higher than on the negative pole, under the PWM control, output duty ratio of the logical circuit will increase and the output voltage will be boosted until a stable state is reached.

In table 2 below are shown testing data of the motor:

TABLE 2

| | Power Supply INPUT | | | | | | | | | |
|---|---|---|---|---|---|---|---|---|---|---|
| | 1.53 V | | 1.44 V | | 1.34 V | | 1.22 V | | 1.12 V | Remarks |
| Motor Voltage | 1.783 | V | 1.784 | V | 1.775 | V | 1.748 | V | 1.784 V | After using |
| Total Electric Current | 30 | MA | 33 | MA | 35 | MA | 38 | MA | 0 | instruments to |
| at Gear 1 | | | | | | | | | | test its rotation |
| Total Electric Current | 47 | MA | 49 | MA | 54 | MA | 58 | MA | 0 | speed, it is |
| at Gear 2 | | | | | | | | | | found the |
| Total Electric Current | 95 | MA | 101 | MA | 112 | MA | 122 | MA | 0 | motor keeps |
| at Gear 3 | | | | | | | | | | the same |
| | | | | | | | | | | rotation speed |
| | | | | | | | | | | under different |
| | | | | | | | | | | voltages. |

During the above step 4, the gear indicators can take both the white and red colors, which use four combinations to indicate different power status. When all indicators take a white color, it means the battery (7) has ample voltage and power; when taking red and white colors, it means the battery has 60% of power; when taking a red color, it means the battery has insufficient power and change of battery (7) is recommended; when both indicators are off, it means power outage.

At voltage above 1.3V, the indicator will turn white, which means full power. At voltage of 1.2-1.3V, the indicator will turn white and red, which means half power. At voltage of 0.95-1.2V, the indicator will turn red, which means low power. At voltage of 0.9-0.95V, the indicator will flicker red, which means extremely low power.

Considering the motor's power and lifespan and the supply voltage, the Ricoh RP401N181D-TR-FE high-power chip is used here, which supports 0.7-1.5V input voltage and 1.8V stable output voltage.

LED lights indicating the 3 gears can take both red and white colors. In table 3 below are shown testing data of the LED lights:

TABLE 3

| | Power Supply INPUT | | | | | |
|---|---|---|---|---|---|---|
| | 1.21 | 1.31 | 1.41 | 1.51 | 1.54 | Remarks |
| LED voltage at | 3.3 V | 3.3 V | 3.3 V | 3.3 V | 3.3 V | Test |
| gear 1 | | | | | | corresponding |
| LED voltage at | 3.3 V | 3.3 V | 3.3 V | 3.3 V | 3.3 V | IO output |
| gear 2 | | | | | | voltage. |
| LED voltage at | 3.3 V | 3.3 V | 3.3 V | 3.3 V | 3.3 V | |
| gear 3 | | | | | | |
| Voltage of White | 3.3 V | 3.3 V | 3.3 V | 3.3 V | 3.3 V | |
| LED | | | | | | |
| Voltage of White | 3.3 V | 3.3 V | 3.3 V | 3.3 V | 3.3 V | |
| LED | | | | | | |

In summary, in the course of hybrid control of the sterilizing UVC lamp (61), the 3-geared LED string lights (62) and the motor (4), constant voltage supply to various electronic devices guarantees stable voltage and lifespan of the machine.

1. A root canal activator, comprising: an oscillatory needle mounted on the top of an outer shell; a battery lid on the bottom of the outer shell and a battery compartment inside the outer shell; wherein the battery lid is screwed on the bottom of the outer shell; a PCB main control board, a motor, and keys are inside the outer shell; wherein the motor is connected with the PCB main control board through key connectors; positive and negative anodes of the PCB main control board, the motor and the keys are respectively connected with positive and negative plates inside a battery compartment by conducting wires; wherein a battery is installed inside the battery compartment;
wherein the PCB main control board is fixed in the front of the outer shell, the keys are embedded into the outer shell; the bottom of the keys contact electronic elements on the PCB main control board during the pressing;
wherein the motor is mounted on the front of a motor support; the motor is connected with an eccentric wheel by an input axis at the front end;
wherein the eccentric wheel is connected with an oscillatory needle, which is composed of a needle, a spherical joint and a connecting rod; the connecting rod is connected through a spherical joint to a ball-shaped slot of the eccentric wheel and therefore a spherical pair allowing for one degree of freedom is created;
wherein a head cover made of soft rubber is mounted at the top end of the outer shell; the oscillatory needle is mounted inside the soft rubber cover through a cylindrical joint, which has formulated a cylindrical pair and allows for four degrees of freedom; five degrees of freedom in total; the oscillatory needle is mounted on a ring slot inside the soft rubber head cover through the cylindrical joint, while a seal is installed between the cylindrical joint and the ring slot;
wherein the needle has a threaded texture;
wherein, a driver board is connected with the PCB main control board; the driver board is wired with UVC lights and three-geared LED string lights; the PCB main control board uses keys to operate the driver board and motor; wherein,
the PCB main control board is comprising a motor driver module, voltage-boosting and voltage-stabilizing modules, MCU controller and indicator controller, wherein the voltage-boosting and voltage-stabilizing module provide constant voltage to the motor driver module, the MCU controller, and the indicator controller when the motor driver module, the MCU controller, and the indicator controller are operated together;
wherein the voltage-boosting and voltage-stabilizing modules include a differential comparator and a preset reference voltage value, which use voltage feedback to modulate value of an output voltage; wherein the voltage-boosting and voltage-stabilizing modules collaborate to control the motor and the three-geared LED string lights display.

2. The root canal activator according to claim 1, wherein, when the MCU controller and the motor driver module control the motor to work at a gear 1, a Pt LED indicator will be lighted by the indicator controller, when the motor works at a gear 2, the 1^{st} LED indicator and a 2^{nd} LED indicator will be lighted; when at a gear 3, the 1^{st} LED indicator, the 2^{nd} LED indicator and the 3^{rd} LED indicator will be lighted.
